(19) United States
(12) Patent Application Publication
(10) Pub. No.: US 2007/0229072 A1
(43) Pub. Date: Oct. 4, 2007

(54) Method and Device for High-Resolution Nuclear Magnetic Resonance Spectroscopy Using a Hyperpolarised Medium

(75) Inventors: Stephan Appelt, Aachen-Soers (DE); Daniel Gembris, Mannheim (DE); Horst Halling, Wilhelmshorst (DE); Richard Patzak, Aachen (DE); Friedrich-Wolfgang Haesing, Julich (DE); Ulrich Sieling, Erkelenz (DE)

Correspondence Address: PEARNE & GORDON LLP, 1801 EAST 9TH STREET, SUITE 1200, CLEVELAND, OH, 44114-3108, US

(73) Assignee: FORSCHUNGSZENTRUM JULICH GMBH, Julich, DE (DE)

(21) Appl. No.: 11/571,372

(22) PCT Filed: Jun. 1, 2005
(86) PCT No.: PCT/EP05/52512

§ 371 Date: Mar. 20, 2007

(30) Foreign Application Priority Data
Jul. 2, 2004 (DE) 102004032080.2

(51) Int. Cl. G01V 3/14

(52) U.S. Cl. 324/316; 324/300

(57) ABSTRACT

The present invention relates to a method as well as a device for analyzing a sample, in particular by MR spectroscopy in weak magnetic fields.

The method according to the invention for analyzing a sample provides that a hyperpolarized medium is added to a sample and that the chemical shift is determined. The hyperpolarization causes a greater extent of alignment of the nuclei, thus improving the signal-to-noise-ratio in the measurement of the chemical shift. Thus, the sample is exposed to an alternating electromagnetic field and a static magnetic field B₀, and the nuclear magnetic resonance is measured. Due to the hyperpolarization, comparatively weak static magnetic fields suffice for determining the chemical shift.

Weak magnetic fields within the sense of the invention are fields having a strength of less than 200 G. For example, they are very weak fields in the range of under B₀=0.001, T=10 G. The advantage of the determination of the chemical shift in weak fields is that appropriate devices can be manufactured and maintained at comparatively low cost.

The present invention relates to a method as well as a device for analyzing a sample by determining a chemical shift in a medium that has been caused by the presence of the sample. It is known from the prior art to carry out such an analysis by means of high-resolution nuclear magnetic resonance (NMR) spectroscopy.

Nuclear magnetic resonance is the measurement of a precessing nuclear spin ensemble oscillating at the Larmor precession frequency about a homogeneous magnetic field. The excitation of the precession is brought about by a resonant high-frequency field. Nuclear magnetic resonance, in addition to magnetic resonance imaging (imaging), is used, in particular for the high-resolution structural elucidation in NMR spectroscopy.

In known methods, the sample tube, which is surrounded by a coil and in which the high-frequency (HF) alternating magnetic field H₁ for exciting the nuclear magnetic resonance in the sample is generated by means of a radio frequency generator, is brought between the poles of a large magnet of the NMR spectrometer. This provides a stable, homogeneous magnetic field B₀, which is perpendicular to the direction of the alternating magnetic field. Resonance occurs when the frequency of the exciting HF field matches the precessing nuclear spin. Given a known nuclear spin I, the Larmor frequency is defined by the magnetic field effective at the position of the nucleus, which, however, does not exactly match the externally applied magnetic field B₀: the applied magnetic field is attenuated by the magnetic field of the orbital electrons and the fields of adjacent nuclei, so that the local effective field strength is normally lower than the applied field strength B₀ (diamagnetic atoms or substances). In exceptional cases, however, the field at the position of the nuclear spin may be amplified (paramagnetic atoms or substances). This effect, which is referred to as shielding, leads to a change of frequency (chemical shift) in the NMR spectrum of the medium examined.

The chemical shift depends on the chemical and physical environment of the observed nucleus. Thus, the determination of the chemical shift in a medium that has been caused by the presence or addition of a sample, makes deductions regarding the sample possible, and thus, enables an analysis of the sample.

Due to their prevalence, the nuclei that are examined the most are protons (¹H-NMR). In addition, ²H, ¹³C, ¹⁹F and ³¹P nuclei are commonly examined.

The known proton spectroscopy methods are disadvantageous in that strong magnetic field of more than 0.1 T must be applied so that, on the one hand, a resonance can at all be found in the spectrum, or for the chemical shift to be large enough in the spectrum to be resolved. The signal-to-noise ratio in small magnetic fields is small.

It is particularly disadvantageous that the strong magnetic fields are comparatively expensive to generate because they must have a sufficiently high homogeneity and time stability, which generally can only be accomplished by superconducting magnets or expensive unwieldy electromagnets. Apart from the large purchasing costs, the operation of such magnets also entails considerable maintenance costs. In addition, it limits the transportability of such apparatuses.

The classic area of application of NMR spectroscopy is chemical structure elucidation, which has particular significance in connection with the analysis of proteins and other macromolecular substances, and is used, for example, in the pharmaceutical and the petroleum industry. Living tissue can also be subjected to measurements by means of NMR spectroscopy. By means of electronic computation methods, NMR cross-section images of plants, animals and of humans can be prepared that represent the distribution of “freely mobile” hydrogen atoms and thus show tissue structures and organs (magnetic resonance imaging).

In view of the above-described disadvantages, it is therefore the object of the present invention to be able to perform an analysis more easily.

This object is solved by a method according to claim 1, as well as by a generic device having the feature of the independent device claim. Advantageous embodiments follow from the dependent claims. In addition, an advantageous use of the device is specified.

By carrying out the analysis of a sample, such as petroleum, with weak homogeneous magnetic fields, the complexity of instrumentation is greatly simplified. Costs can be saved in this manner. The smaller the homogeneous magnetic field, the more easily and cheaply the analysis can be carried out. A measurement in the earth's magnetic field has a particular advantage, because that need not be generated anymore, so that means for providing the homogeneous magnetic field can be dispensed with. The method according to invention for analyzing a sample provides, in particular in order to improve the signal-to-noise ratio, that a hyperpolarized medium is added to a sample and that the chemical shift caused in the hyperpolarized medium by the sample is determined. The Larmor frequency of the medium is measured in order to determine the chemical shift. In the following, this is meant to be the Larmor frequency that occurs in the medium when no sample is present. If the medium is a gas, the Larmor frequency, which occurs when the gas pressure is practically 0, is preferably presumed, for reasons of standardization.

The medium, i.e., for example, the gas, is directed towards the sample and, for example dissolved in the sample. The dissolution of the medium in the sample is primarily successful in those cases where the sample is a liquid. Now, the Larmor frequency of the medium, e.g. of the dissolved gas, is measured. The difference between the Larmor frequencies represents a measure for the chemical shift sought.

The hyperpolarization can be carried out continuously or discontinuously. Basically, all known methods (inter alia, DNP, PHIP) are suitable for this purpose.

The hyperpolarization is achieved in a particularly effective manner by optical spin-exchange pumps, namely in particular by means of high-pressure polarizers and/or transportable polarizers that provide mobility. The nuclei are aligned to a greater extent. The signal-to-noise ratio can thus be improved by several powers of ten.

In order to obtain a particularly large chemical shift, xenon is preferred as a medium. Xenon has the additional advantage that it can be dissolved in a particularly suitable manner in many liquids such as petroleum.

Because of the hyperpolarization, comparatively weak static magnetic fields suffice for determining, for the chemical shift sought, for example, for xenon, or also for ¹³C. Weak magnetic fields within the sense of the invention are, in particular, fields having a strength of less than 200 G. For example, they are very weak fields in the range of 0.001 T, i.e. 10 Gauss. The advantages of the determination of the chemical shift in weak fields are that appropriate devices can be manufactured and maintained at comparably low cost (compared, for example, with superconductor magnets). In addition, an open and compact construction is possible, which in turn permits a mobile operation. Thus, a deployment in remote or even subterraneous environments (for example boreholes) is possible. Coils for generating a B₀ field can be dispensed with, particularly in the case of measuring in earth's magnetic field. Shielding is not required in the method according to the invention. An artificial, weak magnetic field B₀ can be obtained using, for example, simple electromagnets that can be operated with small currents. It is also advantageous that the T2 and T2* times can be very long, and that susceptibility artifacts practically do not occur. The latter is a big problem in the case of strong magnetic fields.

When a measurement in a sufficiently weak magnetic field is carried out, an excitation of the nuclear spin for the determination of the chemical shift can advantageously be effected by means of a direct current magnetic pulse, which makes it possible to keep the electronic system for exciting the nuclear spin very simple. In addition, the skin effect disappears in the case of an excitation by means of a direct current pulse. Excitation of the nuclear spin in that case can also take place by means of conductive materials (e.g. metal pipes), as well as in difficult environments. A magnetic field typically is weak enough if the direct current magnetic pulse is at least twice, preferably three times as big as the static magnetic field. The direct current magnetic pulse preferably has a square-wave form.

In a further embodiment of the invention, hyperpolarized xenon is added to the sample. For example, the polarization of the xenon can take place by means of optical spin-exchange pumping using Rb vapor and natural xenon gas. Hyperpolarized xenon gas can, for example, be generated by means of a jet polarizer as disclosed in the printed publication DE 102004002640.8. Xenon has the advantage that the chemical shift is particularly pronounced in this element. In the case of xenon dissolved in toluene, for example, it amounts to 188 ppm. Xenon has the additional advantage that it can be submerged in a liquid sample having different solubilities, in contrast to ³He.

The decisive advantage of a xenon NMR spectroscopy according to the invention in a liquid consists of the fact that both the line widths as well as the distance between the chemically shifted Xe NMR spectral lines down to the earth's magnetic field scale in a linear manner with B₀. Thus, the spectral resolution is constant over a wide field range.

In another embodiment of the method, the nuclear magnetic resonance or the Larmor frequency of, e.g., xenon gas is used for comparison for the absolute determination of the chemical shift, when xenon is the medium. This nuclear magnetic resonance of xenon gas, which serves as a reference line in the spectrum, is preferably measured at the same time as the Larmor frequency of the xenon dissolved in the sample, in order to thus arrive at meaningful results. For example, a detection coil may be provided for xenon dissolved in the sample liquid and xenon in the gas phase. For example, the chemical shift of xenon gas compared to xenon dissolved in liquid toluene in a measurement is 188 ppm, and the resonance frequency in a magnetic field of 10 G is only 11.78 kHz. The frequency distance between Xe gas and the line of the xenon dissolved in toluene is 2.21 Hz, and the line width of the xenon concentration lines is less than 0.2 Hz. The peaks of Xenon in the gas and liquid phase can thus be clearly distinguished. The limit at which the two lines can still just about be separated, is at 45 mG (approximately 1/10th of earth's magnetic field). This limit, in the case of toluene, is determined by the T1 relaxation time (approx. 100 s) of xenon in the liquid.

The nuclear magnetic resonance of ³He is measured in a further advantageous embodiment of the method. As described above, the xenon gas line can be used as a reference for the determination of the chemical shift of xenon in the sample. The measurement of the chemical shift of xenon can be made difficult, in particular, in earth's magnetic field, by the exact position of the xenon gas line depending on the temperature and the particle density, i.e., the pressure of the xenon gas, and that in many cases, the xenon gas line overlaps the xenon liquid line, namely, when the T₂ time of xenon becomes less than 10 seconds. This problem is solved by the ³He NMR gas line being measured as the reference frequency, instead of the xenon gas line or the Larmor frequency. In order to obtain a sufficient signal strength of the ³He line, ³He is advantageously also hyperpolarized in advance, in particular by optical spin-exchange pumping. The nuclear magnetic resonance signal, i.e. the Larmor frequency of ³He gas, is a comparatively good reference because the exact position of the ³He line in the spectrum is dependent, to a negligible extent, on the temperature and the density of the ³He gas, and because, in earth's magnetic field, the line width of the ³He spectrum is extremely small (T₂˜1000 s or longer). Moreover, the resonance in earth's magnetic field of ³He (approx. 1.6 kHz) lies so far away from xenon (approx. 600 Hz) in the spectrum that the ³He line and the Xe line do not overlap, and thus do not affect each other in a disadvantageous manner.

Advantageously, the nuclear magnetic resonance, i.e. the Larmor frequency of xenon in a sample and ³He is measured simultaneously. This can be achieved by using two separate measurement set-ups (two sample volumes, two resonance circuits, two electronic evaluation systems) for ³He gas as well as for xenon in the sample.

The simultaneous measurement of the signals has the additional advantage that disturbances and fluctuations of the magnetic field or mechanical rotation of the measuring assembly can be corrected by calculation. Finally, the signal of the ³He gas or of the xenon-containing sample liquid can be used for the exact absolute determination of the earth's magnetic field.

The two measurements take place at the same location for comparable reasons.

The two Larmor frequencies are subtracted from one another for determining the chemical shift, and then, the result is divided by the Larmor frequency of the medium. If two different media are used, i.e., for example ³He gas and xenon, dissolved in a sample, then, advantageously, the ³He gas line is first transformed onto the xenon gas line, namely primarily as follows:

The quotient of the gyromagnetic ratios of ³He and ¹²⁹Xenon is calculated, i.e. ^{3He}γ/^{129Xe}γ=α. Then, the measured Larmor frequency of ³He is divided by α and transformed in this manner. This value is now used as a reference value, instead of a measured Larmor frequency of xenon gas.

In order to obtain good results, the static magnetic field has a homogeneity of at least 10⁻⁵/cm³. Homogeneity is defined by ΔB/(B*V), with B: magnetic field, V: volume, ΔB: occurring B field difference.

Regarding the drawing:

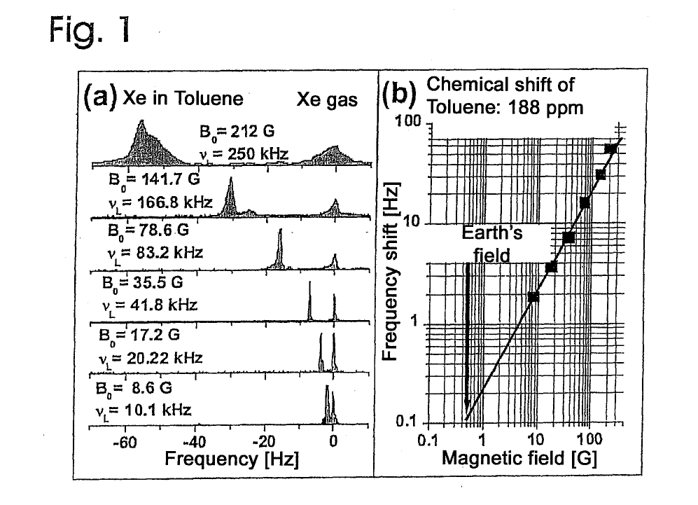

FIG. 1 illustrates that the chemical shift, that is the distance between the resonance peaks of the xenon dissolved in toluene and the xenon in the gas phase, increases in a linear manner with increasing strength of the magnetic field B₀. FIG. 1(a), in particular, shows that the line width of the resonance scales with B₀. That is why a separation of the two resonance lines (xenon gas and xenon in the liquid) is possible down to the earth's magnetic field. Here, oxygen-free toluene serves as example. The xenon T₁˜T₂ time is about 100 s. For this case, the line width of the xenon-toluene line is about 10 mHz, The chemical shift between xenon gas and xenon in toluene in earth's magnetic field is about 0.12 Hz, i.e., the two lines are clearly separated in earth's magnetic field. The limit at which the two lines can still just about be separated, is at 45 mG (approximately 1/10th of earth's magnetic field). The chemical shift makes deductions regarding the type of solvent as well as its temperature possible.

1-14. (canceled)

15. Method for analyzing a sample, comprising the steps:
a) determining by MR spectroscopy, a chemical shift caused in a medium by the presence of a sample;
b) analyzing the sample by the determined shift;
c) characterized in that the MR spectroscopy is carried out with a weak magnetic field of less than 200 Gauss.

16. Method according to claim 15, wherein said weak magnetic field is the earth's magnetic field.

17. Method according to claim 15, wherein the medium is hyperpolarized and added to the sample.

18. Method according to claim 15, wherein the medium is a gas.

19. Method according to claim 15, wherein the gas is xenon.

20. Method according to one of claims 15 or 16, wherein
the Larmor frequency of the medium is determined outside of the sample;
the medium is added to the sample and the Larmor frequency of the medium in the sample is determined;
the chemical shift is calculated from these two Larmor frequencies by calculating the difference between the two determined Larmor frequencies and dividing the difference by the Larmor frequency of the medium measured outside of the medium.

21. Method according to claim 20, wherein the sample is liquid.

22. Method according to claim 20, wherein the weak magnetic field (B) has a homogeneity (Delta B/[B*Volume]) of at least 10⁻⁵/cm³.

23. Method according to claim 15, wherein the Larmor frequency of a first medium located outside of the sample is measured, and wherein the Larmor frequency of a second medium located in the sample is measured, and wherein the chemical shift is determined from these two Larmor frequencies.

24. Method according to claim 23, wherein the first medium is ³HE or ¹³C.

25. Method according to one of claims 23 or 24, wherein the Larmor frequency of the first medium is transformed onto the Larmor frequency of the second medium for determining the chemical shift.

26. Method according to one of claims 23 or 24, wherein the Larmor frequencies measured for the purpose of determining the chemical shift are measured at the same time and/or at the same location.

27. Method according to claim 1, wherein the nuclear magnetic resonance is excited with a magnetic direct current pulse.

28. Spectrometer suitable for carrying out MR spectroscopic measurements according to claim 20, comprising means for hyperpolarizing gases as well as means for measuring Larmor frequencies of gases and means for carrying out the analysis of a liquid from the Larmor frequencies.

29. A method for analyzing petroleum comprising performing the steps of claim 15 using the spectrometer of claim 28.
